(19) United States
(12) Patent Application Publication
(10) Pub. No.: US 2009/0146952 A1
(43) Pub. Date: Jun. 11, 2009

(54) DISPLAY SYSTEM AND LIQUID CRYSTAL DISPLAY DEVICE

(76) Inventor: Hitoshi HIROHATA, Hashimoto-shi (JP)

Correspondence Address: BIRCH STEWART KOLASCH & BIRCH, PO BOX 747, FALLS CHURCH, VA, 22040-0747, US

(21) Appl. No.: 12/331,037

(22) Filed: Dec. 9, 2008

(30) Foreign Application Priority Data
Dec. 11, 2007 (JP) 2007-319967

(51) Int. Cl. G06F 3/033

(52) U.S. Cl. 345/158

(57) ABSTRACT

A display system includes a liquid crystal display apparatus and an operating device. The operating device can point a desired position on a display screen of the display apparatus and capture an image of the display apparatus to obtain the captured image including the desired position pointed by the operating device. The display system includes an image analyzing section for analyzing the captured image obtained by the capture to find reference light areas in the display apparatus and to detect the desired position on the display screen based on positions of the reference light areas in the captured image. The display apparatus also includes a blinking controlling section which controls blinking conditions of all the backlight units in the display apparatus to differ a blinking condition of two or more reference light area backlight units from that of the other backlight units. This allows properly detecting the desired position on the display screen pointed by the operating device.

This Nonprovisional application claims priority under 35 U.S.C. § 119(a) on Patent Application No. 319967/2007 filed in Japan on Dec. 11, 2007, the entire contents of which are hereby incorporated by reference.

### FIELD OF THE INVENTION

The present invention relates to a display system that is capable of detecting a position, on a screen, which is pointed by an operating device such as a pointer.

### BACKGROUND OF THE INVENTION

Recently, thickness of display apparatuses such as liquid crystal displays and plasma displays have been reduced. Further, display apparatuses that have a large screen size have been prevailing.

Such a large-size flat panel display apparatus may be used, for example, in presentation in a meeting, presentation for introducing a product or the like, or as a display apparatus for a video game. Also, a display system is known which includes a display screen, an operating device (pointer) for pointing a position (point) on an image that is displayed on the display screen, a calculation section for calculating coordinates of the position pointed by the operating device (coordinates of the position on the display screen), and a display controlling section for displaying a mark on the pointed position based on the detected coordinates so that the mark overlaps the image on the screen.

For example, Patent Document 1 discloses a technique for detecting coordinates of a pointed position on a display screen. In the technique, (i) light emitting devices (reference light area) provided to front and rear ends of a pointer are driven in different blinking patterns, respectively, (ii) images including the light emitting devices that are provided to the front and rear ends of the pointer are captured by cameras that are provided on the right and left sides of the display screen, respectively, and (iii) coordinates of a pointed position on the display screen is calculated by analyzing a direction (angle) and a distance of light according to the images captured by the cameras.

Further, Patent Document 2 discloses a system that detects coordinates of a position, on a display screen, which is pointed by an operating device. In this system, two LEDs that emit infrared light are provided in the vicinity of the display screen, for example, at an upper part or a lower part of the display screen, (ii) images of the both LEDs (reference light area) are captured by an image sensing device provided in an operating device (a controller in the Patent Document 2), (iii) coordinates of a pointed position on the display screen is calculated based on positions of the two LEDs in the captured images.

Patent Document 1: Japanese Unexamined Patent Publication, Tokukai, 66080/2007 (date of publication: Mar. 15, 2007)

Patent Document 2: Japanese Unexamined Patent Publication, Tokukai, 83024/2007 (date of publication: Apr. 5, 2007)

However, the above conventional techniques may fail to detect coordinates of a point pointed by an operating device when the operating device is close to a display device. The following description deals with this problem in details.

As for the technique as disclosed in Patent Document 1, cameras for capturing images of the light emitting devices (reference light areas) of the operating device are provided on the left and right sides of the display screen. Therefore, in a case where a position of the pointer is close to the display screen, the light emitting devices may be in a position out of a range in which the camera can capture an image.

As for the technique as disclosed in Patent Document 2, an image sensing device provided in an operating device (controller) is arranged to capture an image of the LED (reference light area) that is provided at an upper part or a lower part of the display screen. Therefore, as in the case of Patent Document 1, in a case where a position of the controller is close to the display screen, the LED may be in a position out of a range in which the image sensing device can capture an image.

FIG. 1 and FIG. 2 are explanatory views each illustrating a relation of (i) a distance between an operating device 101 and a display apparatus 102 and (ii) a range in which a position that is pointed by the operating device 101 can be detected, in the same arrangement as the arrangement disclosed in Patent Document 2.

As illustrated in FIG. 1, in a case where a distance between the display apparatus 102 and the operating device 101 is sufficiently large, an LED 103 is included within a range in which the image sensing device that is provided in the operating device 101 can capture an image. Therefore, in such a case, a position pointed by the operating device 101 can be properly detected.

On the other hand, as illustrated in FIG. 2, in a case where a distance between the display apparatus 102 and the operating device 101 is short, the LED 103 cannot be within a range in which the image sensing device can capture an image, depending on a position pointed by the operating device 101 (FIG. 2(b)). In such a case, the position pointed by the operating device 101 cannot be detected.

### SUMMARY OF THE INVENTION

The present invention is attained in view of the above problem. An object of the present invention is to appropriately detect a position, on a display screen, which is pointed by an operating device, regardless of a distance between the operating device and a display apparatus.

A display system of the present invention includes a liquid crystal display apparatus including a display screen; a plurality of backlight units for illuminating the display screen; and a blinking controlling section for controlling a blinking action of each of the plurality of backlight units, an operating device which is capable of pointing a position on the display screen of the liquid crystal display apparatus from a distance and capturing an image of the liquid crystal display apparatus so as to obtain the captured image including the pointed position; and an image analyzing section for analyzing the captured image obtained by the capture and detecting two or more reference light areas in the liquid crystal display apparatus so that the image analyzing section detects the pointed position on the display screen based on positions of the reference light areas in the captured image, the blinking controlling section controlling blinking conditions of all the backlight units provided in the liquid crystal display apparatus so as to differ a blinking condition of two or more reference light area backlight units from that of the other backlight units, so that the image analyzing section detects (recognizes) the reference light area backlight units as the reference light areas.

The structure allows two or more backlight units among the plurality of backlight units, which are provided inside the liquid crystal display apparatus, to function as the reference light areas. Therefore, the reference light areas are located inside the display screen. This can prevent the reference light areas of the liquid crystal display apparatus from being out of a range in which the operating device can capture an image, even though a distance between the liquid crystal display apparatus and the operating device is short, unlike a conventional arrangement in which reference light areas are provided outside of a frame of a display screen. Therefore, it is possible to detect a position, on the display screen, pointed by an operating device more properly than before, regardless of a distance between the operating device and the liquid crystal display apparatus.

Additional objectives, features, and strengths of the present invention will be made clear by the description below. Further, the advantages of the present invention will be evident from the following explanation in reference to the drawings.

### BRIEF DESCRIPTION OF THE DRAWINGS

FIG. 1(a) is an explanatory view illustrating a range in which a position pointed by an operating device can be detected in a display system in accordance with a conventional technique, in a case where (i) a distance between the operating device and a display apparatus is long and (ii) a head part of the operating device points oblique upward. FIG. 1(b) is an explanatory view illustrating a range in which a position pointed by an operating device can be detected in a display system in accordance with a conventional technique, in a case where (i) a distance between the operating device and a display apparatus is long and (ii) a head part of the operating device points oblique downward.

FIG. 2(a) and is an explanatory view illustrating a range in which a position pointed by an operating device can be detected in a display system in accordance with a conventional technique, in a case where (i) a distance between the operating device and a display apparatus is short and (ii) a head part of the operating device points oblique upward. FIG. 2(b) is an explanatory view illustrating a range in which a position pointed by an operating device can be detected in a display system in accordance with a conventional technique, in a case where (i) a distance between the operating device and a display apparatus is short and (ii) a head part of the operating device points oblique downward.

FIG. 3 is a block diagram illustrating an overview structure of a display system of an embodiment in accordance with the present invention.

FIG. 4 is a block diagram illustrating an overview structure of a liquid crystal display apparatus of an embodiment in accordance with the present invention.

FIG. 5 is a schematic view illustrating an overview structure of a sub-pixel provided in a display section of a liquid crystal display apparatus of an embodiment in accordance with the present invention.

FIG. 6 is a cross-section view illustrating a display section provided in a liquid crystal display apparatus of an embodiment in accordance with the present invention.

FIG. 7 is a block diagram illustrating a structure of an image analyzing section provided in an operating device of an embodiment in accordance with the present invention.

FIG. 8 is an explanatory view illustrating a pixel provided in a liquid crystal display apparatus of an embodiment of the present invention.

FIG. 9 is an explanatory view illustrating a relation between a pixel and a backlight unit both of which are provided in a liquid crystal display apparatus of an embodiment in accordance with the present invention

FIG. 10 is an elevation view illustrating a display screen of a liquid crystal display apparatus of an embodiment in accordance with the present invention.

FIG. 11 is a first timing chart showing activation timings of backlight units provided in a liquid crystal display apparatus of an embodiment in accordance with the present invention.

FIG. 12 is a second timing chart showing activation timings of backlight units provided in a liquid crystal display apparatus of an embodiment in accordance with the present invention.

FIG. 13 is a third timing chart showing activation timings of backlight units provided in a liquid crystal display apparatus of an embodiment in accordance with the present invention.

FIG. 14(a) is a view illustrating a display screen at a time t1. FIG. 14(b) is a view illustrating a display screen at a time t2 after the time t1. FIG. 14(c) is a view illustrating a display screen at a time t3 after the time t2. FIG. 14(d) is a view illustrating a display screen at a time t4 after the time t3.

FIG. 15 is a fourth timing chart showing activation timings of backlight units provided in a liquid crystal display apparatus of an embodiment in accordance with the present invention.

FIG. 16 is a fifth timing chart showing activation timings of backlight units provided in a liquid crystal display apparatus of an embodiment in accordance with the present invention.

FIG. 17(a) is an explanatory view illustrating a coordinate system of a display screen in a liquid crystal display apparatus of an embodiment in accordance with the present invention. FIG. 17(b) is an explanatory view illustrating a coordinate system of a captured image in a case where the display screen illustrated in FIG. 17(a) is captured by an image sensing device provided in an operating device.

FIG. 18 is a block diagram illustrating an overview structure of a display system of a modification.

FIG. 19 is an explanatory view illustrating a look-up table stored in the memory section illustrated in FIG. 18.

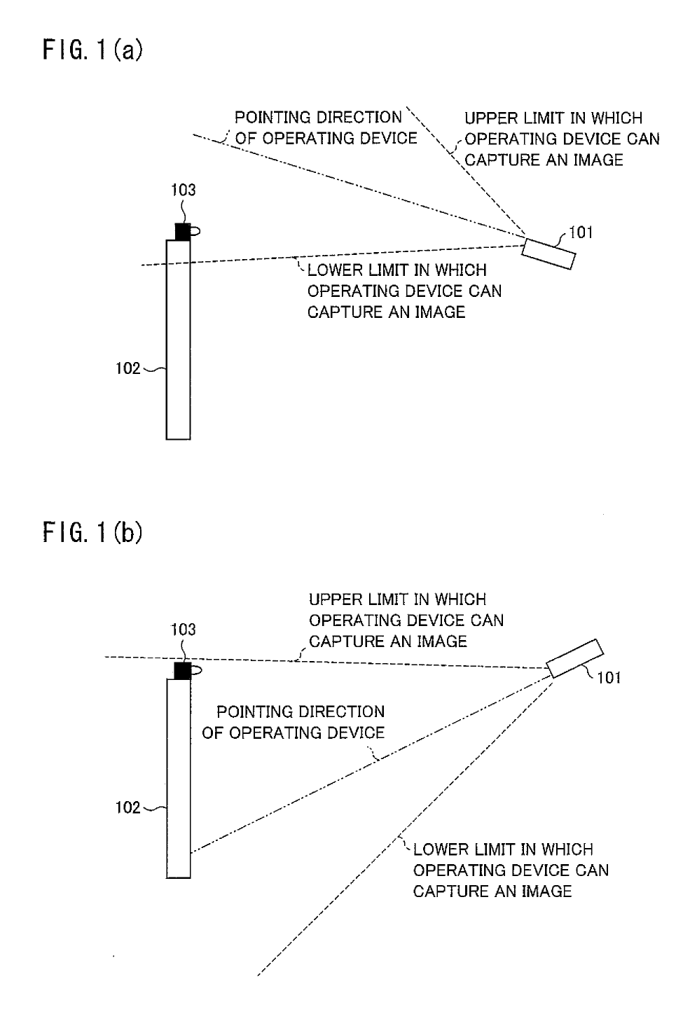

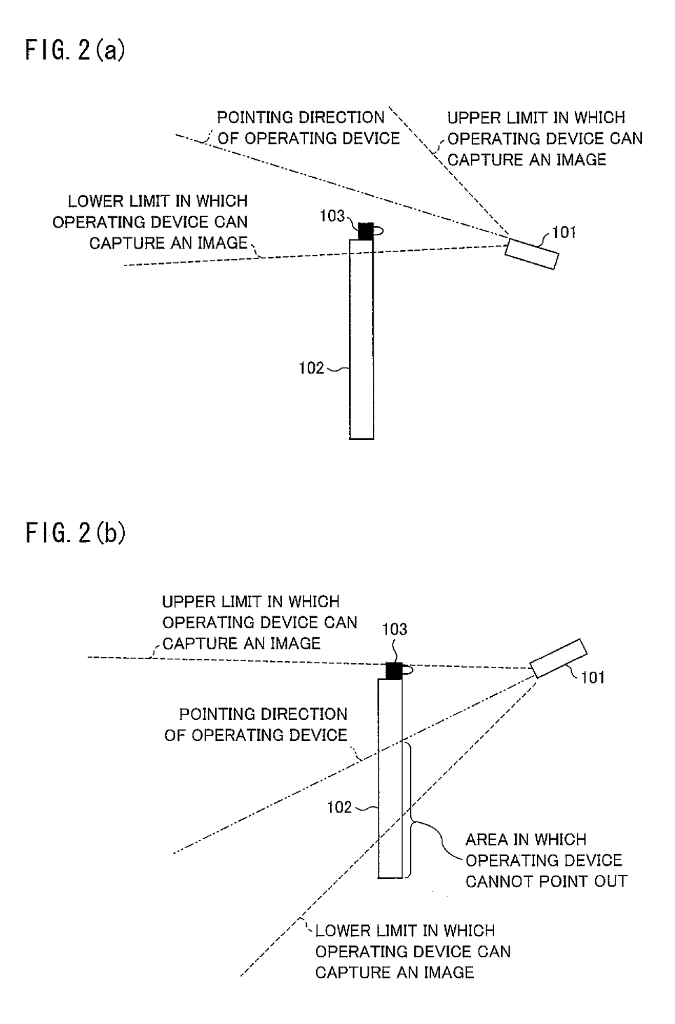

### DESCRIPTION OF THE EMBODIMENTS

### Overview Explanation

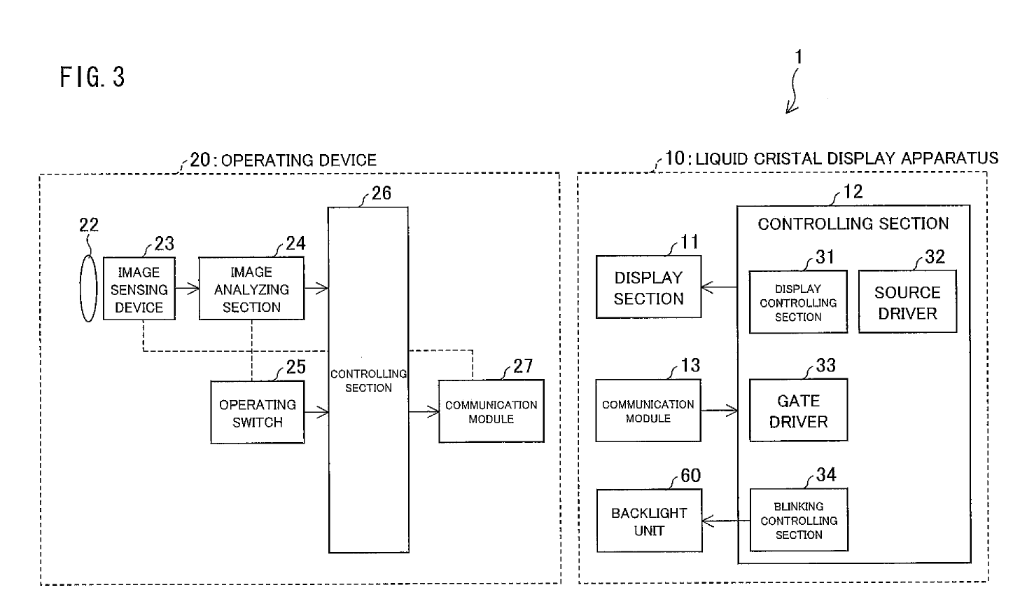

The following description deals with an overview of an embodiment in accordance with the present invention. FIG. 3 is a block diagram illustrating a display system 1 of the present embodiment. As illustrated in FIG. 3, the display system 1 includes a liquid crystal display apparatus 10 and an operating device 20.

The operating device 20 is a pointer. When a user points a head part of the operating device 20 toward a position (user's desired position) on a display screen of the liquid crystal display apparatus 10, the operating device 20 captures an image of the display screen of the liquid crystal display apparatus 10 so as to obtain the captured image including the pointed position. Further, an image analyzing section 24 provided in the operating device 20 analyzes the captured image so as to (i) find two reference light areas in the liquid crystal display apparatus 10 and (ii) detect the pointed position on the display screen based on positions of the two reference light areas in the captured image.

The liquid crystal display apparatus 10 of the present embodiment includes a plurality of backlight units 60 . . . . Among the plurality of backlight units 60 . . . , a blinking condition of two reference light area backlight units 60a and 60b (i.e. two backlight units 60a and 60b functioning as reference light areas) and a blinking condition of the other backlight units are different so that the image analyzing section 24 detects (recognizes) the reference light area backlight units 60a and 60b as the reference light areas. With the structure, as illustrated in FIG. 10, the reference light area backlight units 60a and 60b are provided inside the display screen 90 of the liquid crystal display apparatus 10 as the reference light areas. This can prevent the reference light areas of the liquid crystal display apparatus 10 from being out of a range in which the operating device 20 can capture an image, even though a distance between the liquid crystal display apparatus 10 and the operating device 20 is short, unlike a conventional structure in which reference light areas are located outside of a frame of a display screen. As a result, it is possible to detect a position, on the display screen, pointed by the operating device 20 more properly than the conventional structure, regardless of a distance between the liquid crystal display apparatus 10 and the operating device 20.

The following description deals with structures of the liquid crystal display apparatus 10 and the operating device 20 one after another, and then deals with an operation of the display system 1.

### [Structure of Liquid Crystal Display Apparatus]

The liquid crystal display apparatus 10 is a transmissive liquid crystal display module which includes a plurality of backlight units 60. As illustrated in FIG. 3, the liquid crystal display apparatus 10 includes a display section 11, a controlling section 12, and a communication module 13. For convenience of explanation, only one backlight unit 60 is illustrated in FIG. 3, however, a plurality of backlight units is actually provided.

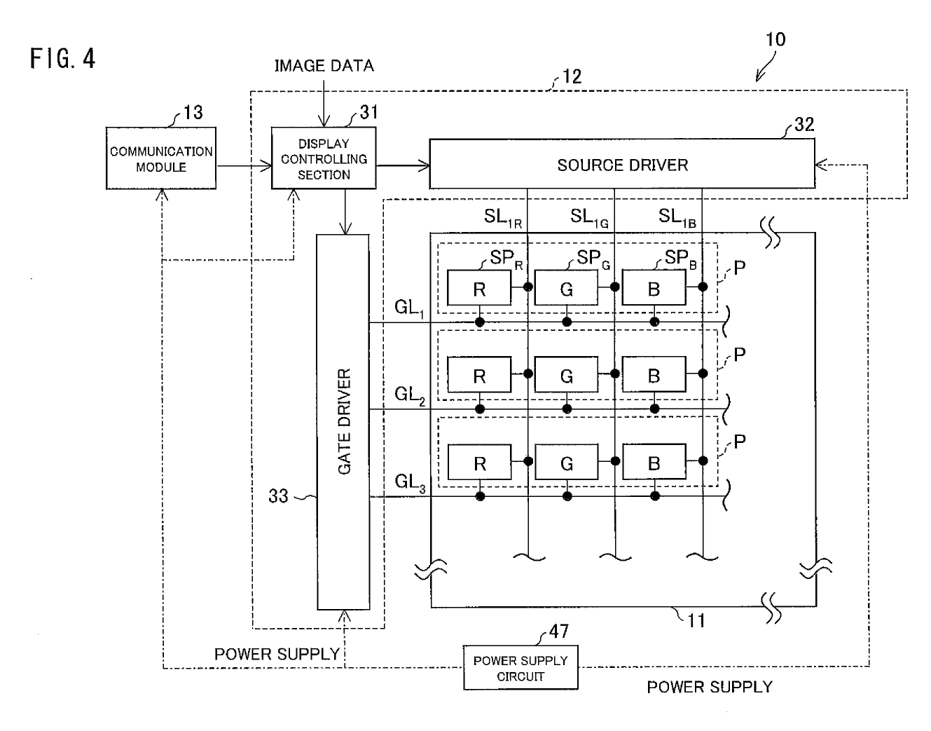

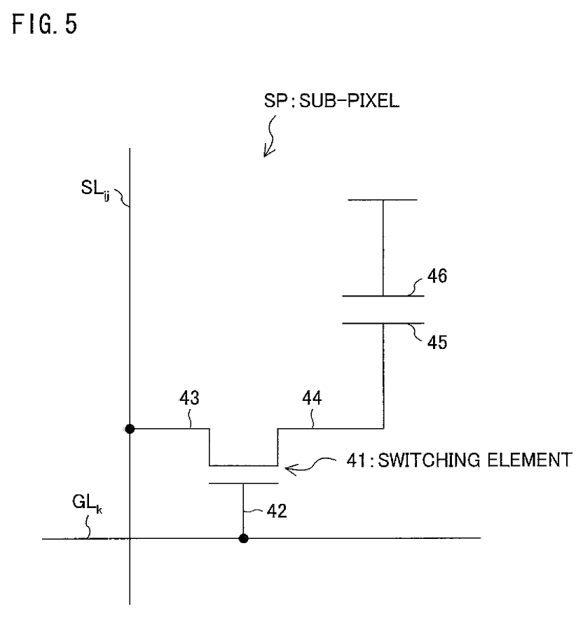

FIG. 4 is a block diagram illustrating an overview structure of the liquid crystal display apparatus 10. FIG. 5 is a schematic view illustrating an overview structure of a sub-pixel in the liquid crystal display apparatus 10 illustrated in FIG. 4.

As illustrated in FIG. 4, the liquid crystal display apparatus 10 includes a display section (display screen) 11 including many pixels P each of which is made of SP_{R} (sub-pixel for red color), SP_{G} (sub-pixel for green color), and SP_{B} (sub-pixel for blue color), a controlling section 12 for controlling the display section 11, a communication module 13 for carrying out data transmission to/data reception from the operating device 20, and a power supply circuit 47 for supplying electric power to each of these sections.

In the controlling section 12, as illustrated in FIG. 3 and FIG. 4, a display controlling section 31, a source driver 32, and a gate driver 33 are provided. Further, the display section 11 includes a plurality of data signal lines SL_{1R}, SL_{1G}, SL_{1B}, . . . SL_{nR}, SL_{nG}, and SL_{nB} (“n” represents any integer not less than 2), and a plurality of scanning signal lines GL₁ . . . GLₘ (“m” represents any integer not less than 2) each of which intersects with each of the data signal lines. The sub-pixel is provided at each intersection of the data signal lines and the scanning signal lines.

The display controlling section 31 controls an intensity of light that passes through each of the sub-pixels by controlling respective operations of the source driver 32 and the gate driver 33, so that an image in accordance with image data inputted to the display controlling section 31 is displayed on the display section 11. The image data may be, for example, (i) data that is inputted from an external device (not illustrated) that is communicably connected to the liquid crystal display apparatus 10, (ii) data that is read out from a memory section (not illustrated) provided in the liquid crystal display apparatus 10, or (iii) a broadcast data that is received via reception means (not illustrated) such as an antenna or a tuner.

The display controlling section 31 detects a position, on the display screen, pointed by the operating device 20 based on information received from the operating device 20 via the communication module 13. The display controlling section 31 controls the respective operations of the source driver 32 and the gate driver 33 so that a predetermined image (image such as a mark indicating a pointing position) is displayed at the pointed position.

The source driver 32 generates a driving voltage (image signal) for driving each of the sub-pixels in accordance with image data, and applies the driving voltage to each of the data signal lines. The gate driver 33 controls a timing of a scanning signal to be applied to each of the scanning signal lines, so that the driving voltage outputted from the source driver 32 is sequentially supplied at a predetermined timing to each of the sub-pixels that are provided along each of the data signal lines. Any conventionally known drivers can be used as the source driver 32 and the gate driver 33.

As illustrated in FIG. 5, each of the sub-pixels is provided with a switching element 41. For instance, the switching elements 41 may be FETs (Field Effect Transistors), TFTs (Thin Film Transistors) made of a transparent electrode (ITO (Indium Tin Oxide; indium, tin, oxide film) or tin oxide), or the like.

In FIG. 5, a gate electrode 42 of the switching element 41 is connected to a scanning signal line GLₖ (“k” represents any integer from 1 through m). A source electrode 43 is connected to a data signal line SLᵢⱼ (“i” represents any integer from 1 through n, and “j” represents R, G, or B). Further, a drain electrode 44 is connected to a sub-pixel electrode 45. A counter electrode 46 provided so as to be opposed to the sub-pixel electrode 45 is connected to a common electrode line (not illustrated) that is common to all the sub-pixels.

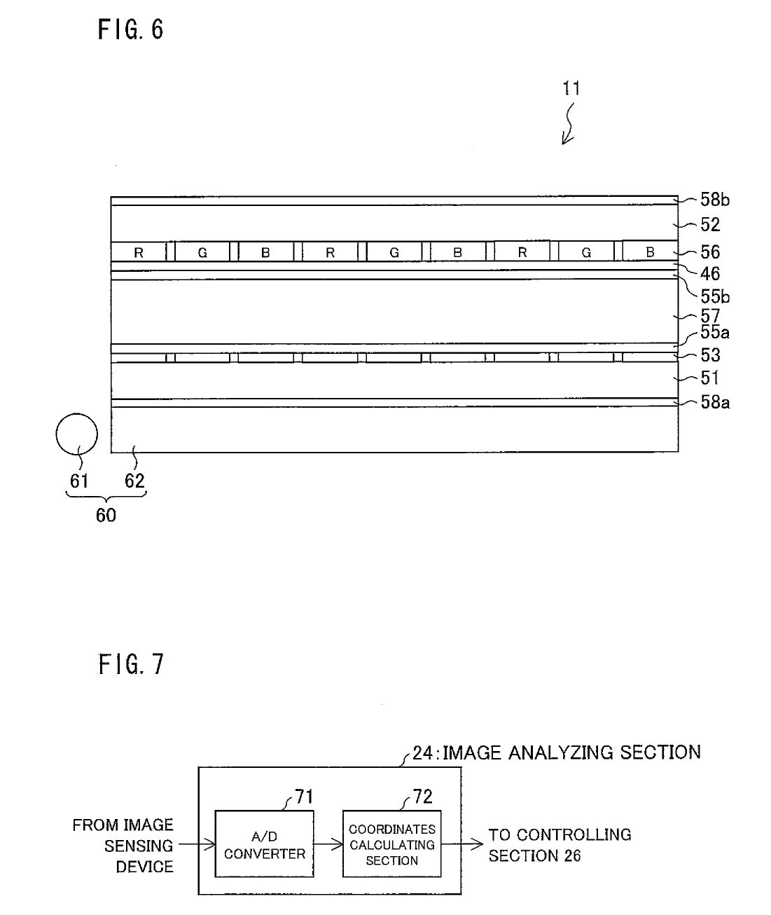

FIG. 6 is a cross-section view of the display section 11. As illustrated in FIG. 6, the display section 11 includes glass substrates 51 and 52 and a liquid crystal layer 57. The glass substrates 51 and 52 are provided by using a spacer (not illustrated) so as to face each other and to keep a predetermined space between the glass substrates 51 and 52. The liquid crystal layer 57 is made of a liquid crystalline material that is sealed in between the glass substrates 51 and 52. For example, the liquid crystalline material may be a generally used liquid crystalline material such as a nematic liquid crystal, a smetic liquid crystal, or a ferroelectric liquid crystal.

On a surface of the glass substrate 51 that faces the glass substrate 52, a wiring layer 53, and an alignment film 55a are provided. The wiring layer 53 is provided with, for example, the data signal lines SL_{1R}, SL_{1G}, SL_{1B}, . . . , the scanning signal lines GL1, . . . , the switching element 41, and the sub-pixel electrode 45. The alignment film 55a is formed so as to cover the wiring layer 53. Further, on a surface on a side opposite to the surface of the glass substrate 51 that faces the glass substrate 52, a polarization plate 58a is provided. Further, a backlight unit 60 is provided so as to face the polarization plate 58a.

On a surface of the glass substrate 52 that faces the glass substrate 51, a color filter layer 56, the counter electrode 46 made of a transparent conductive film, and an alignment film 55b are formed in this order. The alignment film 55b is formed so as to cover the counter electrode 46. On a surface on a side opposite to the surface of the glass substrate 52 that faces the glass substrate 51 is provided with a polarization plate 58b.

A direction of alignment treatment that is applied to each of the alignment films 55a and 55b, and a direction of absorption axis of each of the polarization plates 58a and 58b may be set according to a type of a liquid crystalline substance that is sealed in the liquid crystal layer 57, in the same manner as a conventionally known liquid crystal display apparatus. In the present embodiment, the sub-pixel electrode 45 and the counter electrode 46 are provided to different substrates, respectively. However, the present invention is not limited to this. Both the sub-pixel electrode 45 and the counter electrode 46 may be provided on the same substrate, that is, in a so-called IPS method.

In the color filter layer 56, a filter is provided to each of the sub-pixels. The filter transmits light having a wavelength in a wavelength region corresponding to one of R, G, and B, and shields light having wavelengths in other wavelength regions.

The backlight unit 60, as illustrated in FIG. 6, includes a light source unit 61, and a reflecting section (light guide plate) 62. The backlight unit 60 reflects light irradiated from the light source unit 61 by the reflecting section 62 so as to irradiate light on the display section 11. A diffusion film may be provided between the backlight unit 60 and the display section 11. This diffusion film is for providing uniform irradiation on an entire display surface of the display section 11 by diffusing light emitted from the light source 61.

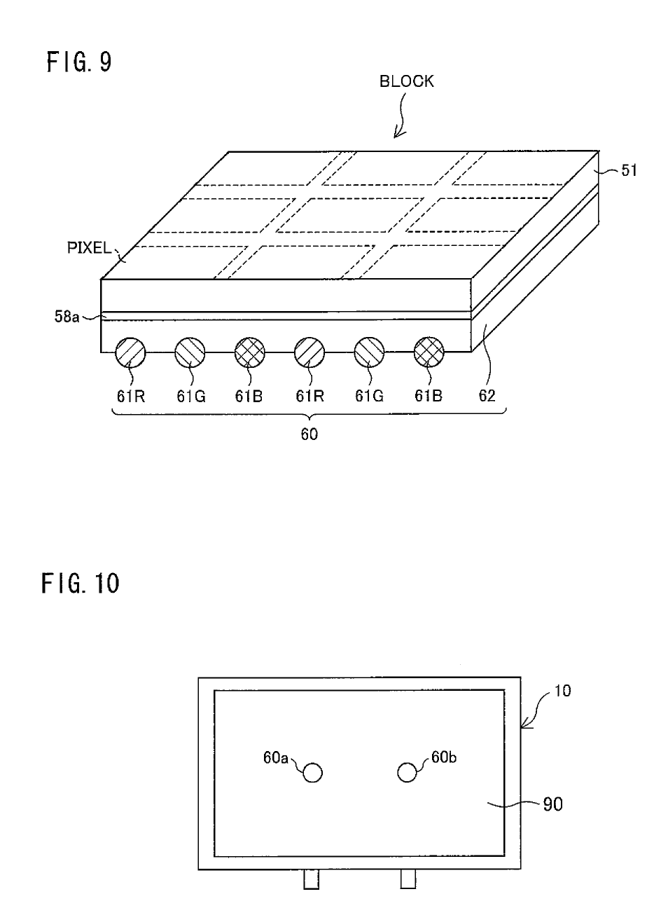

The light source unit 61, as illustrated in FIG. 9, is a combination of LED 61R for emitting red light, LED 61G for emitting green light, and LED 61B for emitting blue light. Simultaneous drive of each of the LED 61R for red color, LED 61G for green color, and LED 61B for blue color causes the light source unit 61 to emit white light. The light source unit 61 is not specifically limited to the above arrangement and may be a white color LED for emitting white light.

In the liquid crystal display apparatus 10 with the arrangement, when the scanning signal line GLₖ is selected by supplying a scanning signal to the scanning signal line GLₖ, the switching element 41 of each of the sub-pixels that are connected to the selected scanning signal line GLₖ is turned on. Then, the source driver 32 applies, between the sub-pixel electrode 45 and the counter electrode 46 via the data signal line SLᵢⱼ, a driving voltage that is determined in accordance with image data that is supplied to the display controlling section 31. Between the sub-pixel electrode 45 and the counter electrode 46, ideally, a voltage obtained when the switching element 41 is turned off is kept during the time in which the switching element 41 is turned off after an end of a selecting period of the scanning signal line GLₖ. This causes a driving voltage to be applied to between the sub-pixel electrode 45 and the counter electrode 46 in each of the sub-pixels, independently, so that an electric filed in accordance with an image to be displayed is applied to each sub-pixel region of the liquid crystal layer that is provided between the sub-pixel electrode 45 and the counter electrode 46. As a result, an alignment state of liquid crystal molecules is changed in each sub-pixel region so that the image is displayed.

According to the arrangement, the liquid crystal display apparatus 10 controls an intensity of light that passes through the sub-pixel region of the liquid crystal layer 57 by controlling a voltage that is applied between the pixel electrode 45 and the counter electrode 46 of each of the sub-pixels. As a result, a color display is performed.

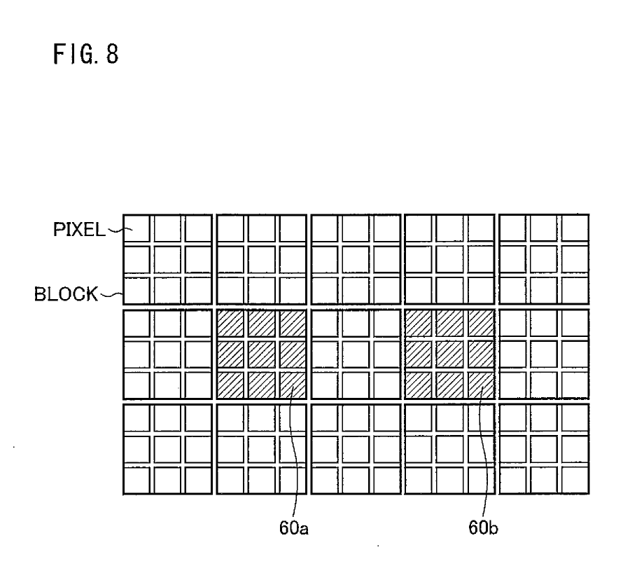

As illustrated in FIG. 8, in the liquid crystal display apparatus 10 of the present embodiment, for example, 3×3 pixels are set to be one block, and a backlight unit 60 is provided in every block as illustrated in FIG. 9. Namely, the liquid crystal display apparatus 10 includes a large number of (a plurality of) backlight units 60 . . . . Light is supplied to 9 pixels in one block from a correspondingly provided backlight unit 60. For convenience of an explanation, one block is made of 3×3 pixels herein. However, a size of one block is not specifically limited to this. For example, one block may have an area of 1×1 cm² to be recognized as a light area.

Further, the controlling section 12 of the liquid crystal display apparatus 10 of the present embodiment includes a blinking controlling section 34 for controlling a blinking action of each of the backlight units 60, as illustrated in FIG. 3. The blinking controlling section 34 controls blinking conditions of all the backlight units 60 . . . provided in the liquid crystal display apparatus 10 so as to differ at least a blinking condition of reference light area backlight units 60a and 60b from a blinking condition of the backlight units 60 . . . other than the reference light area backlight units 60a and 60b (called normal backlight units hereinafter).

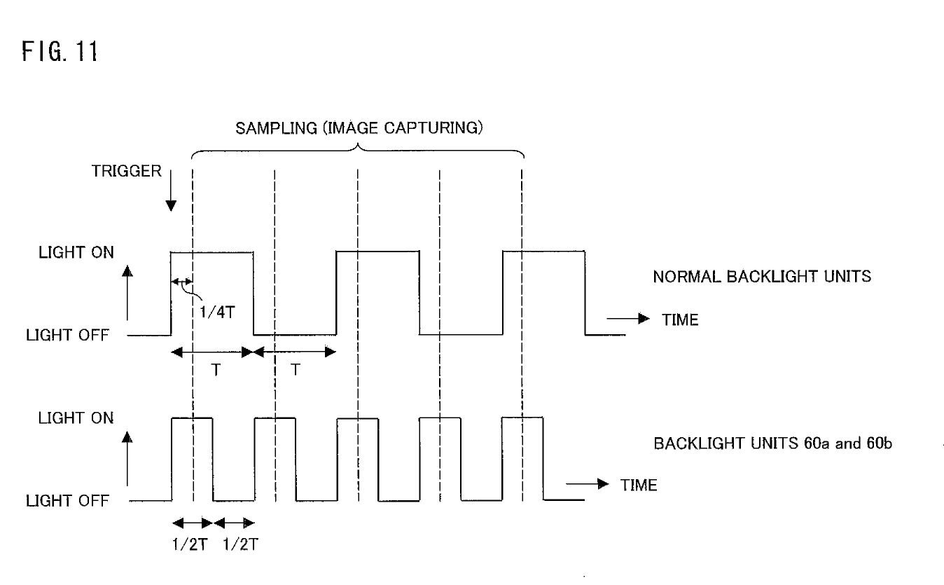

More specifically, the blinking controlling section 34 controls a blinking action of the normal backlight units 60 and a blinking action of the reference light area backlight units 60a and 60b in accordance with a timing chart as illustrated in FIG. 11.

Namely, the blinking action of the reference light area backlight unit 60a and the blinking action of the reference backlight unit 60b are the same. Further, the blinking action of the reference light area backlight units 60a and 60b is different from the blinking action of the normal backlight units 60. The blinking action of the normal backlight units 60 repeats light-on and light-off in such a manner that T hour light-on period and T hour light-off period are combined as one cycle. The blinking action of the reference light area backlight units 60a and 60b repeats light-on and light-off in such a manner that (½) T hour light-on period and (½) T hour light-off period are combined as one cycle. Further, the blinking controlling section 34 controls both the normal backlight units 60 and the reference light area backlight units 60a and 60b to turn on simultaneously at an input timing of a trigger signal for indicating activation of the backlight units.

As illustrated in FIG. 11, light-on timings of the reference light area backlight units 60a and 60b are always in sync with a light-on timing or a light-off timing of the normal backlight units 60. A light-on period of the reference light area backlight units 60a and 60b is included in a light-off period of the normal backlight units 60. Therefore, as illustrated in FIG. 8 through FIG. 10, momentarily and periodically, only the reference light area backlight units 60a and 60b emit light inside the display screen 90 in the liquid crystal display apparatus 10. (Namely, inside the display screen 90, momentarily and periodically, the reference light area backlight units 60a and 60b emit light while turning off all the normal backlight units 60.)

### [Structure of Operating Device]

The following description deals with an operating device 20 in details. The operating device 20 includes a lens 22, an image sensing device 23, an image analyzing section 24, an operating switch 25, a controlling section 26, and a communication module 27, as illustrated in FIG. 3. Further, the operating device 20 is capable of pointing any position on the display screen 90 by pointing a head part of the operating device 20 towards the position on the display screen 90 of the liquid crystal display apparatus 10.

The lens 22 is provided in the head part of the operating device 20 for focusing incoming light from the head part of the operating device 20 on the image sensing device 23. The image sensing device 23 is made of, for example, a CMOS or a CCD. The image sensing device 23 capture an external image of the operating device 20 by receiving incoming light from the head of the operating device 20 via the lens 22. The image sensing device 23 transmits a captured image to the image analyzing section 24.

A center in a direction in which the image is captured by the image sensing device 23 (i.e., a direction of an optical axis of the lens 22) is substantially coincided with a pointing direction of the operating device 20 (i.e. a direction of a straight line connecting a pointed position on the display screen and the head part of the operating device 20). Accordingly, the center of the captured image corresponds to the pointed position on the display screen 90 (the position pointed by the operating device 20).

As illustrated in FIG. 7, the image analyzing section (image processing module) 24 includes an A/D converter 71, and a coordinates calculating section 72. The A/D converter 71 receives a captured image from the image sensing device 23 and converts analogue image signal of the captured image to digital image data. The coordinates calculating section 72 detects a position, on the display screen 90, pointed by the operating device 20 based on the image data (captured image) supplied from the A/D converter 71. A process carried out by the image analyzing section 24 is to be described later in details.

The operating switch 25 receives an instruction input from a user. The operating switch 25 includes many button keys or the like.

The controlling section 26 controls an operation of each section provided in the operating device 20. Further, the controlling section 26 generates information to be transmitted to the liquid crystal display apparatus 10, based on, for example, (i) a result of analysis by the image analyzing section 24 and (ii) information inputted by a user from the operating switch 25.

The communication module 27 carries out data transmission to/data reception from the communication module 13 in the liquid crystal apparatus 10. For example, the communication module 27 transmits information that is supplied from the controlling section 26 to the liquid crystal display apparatus 10. A communication medium that is employed by the communication module 27 is not specifically limited. The communication medium may be a wireless medium or a wired line medium.

### [Operation of Display System]

The following description deals with an operation of the display system 1. Firstly, the blinking controlling section 34 in the liquid crystal display apparatus 10 inputs a trigger signal for indicating activation of the backlight units 60. Then all the backlight units 60 . . . provided in the liquid crystal display apparatus 10 start driving. As a result, the reference light area backlight units 60a and 60b and the normal backlight units 60 . . . repeat a blinking action in accordance with a timing chart as shown in FIG. 11. Accordingly, as shown in FIG. 8 and FIG. 10, momentarily and periodically, only the reference light area backlight units 60a and 60b emit light inside the display screen 90 in the liquid crystal display apparatus 10. Namely, momentarily and periodically, the reference light area backlight units 60a and 60b emit light as reference light areas inside the display screen 90 of the liquid crystal display apparatus 10.

The controlling section 26 in the operating device 20 causes the image sensing device 23 to capture an image of the display screen 90 of the liquid crystal display apparatus 10. The controlling section 26 in the operating device 20 detects a timing when a trigger signal for indicating activation the backlight units 60 is inputted to the blinking controlling section 34 through communications with the liquid crystal display apparatus 10, and causes the image sensing device 23 to capture the first image at a time when (¼) T hour passed from the timing (see FIG. 11). After capturing the first image, the controlling section 26 in the operating device 20 causes the image sensing device 23 to capture an image of the display screen 90 in every T hours. The captured images are transmitted to the image analyzing section 24.

Accordingly, as illustrated in FIG. 11, an image capture is repeated alternately (i) at a timing when all the backlight units 60 . . . provided in the liquid crystal display apparatus turn on and (ii) at a timing when the normal backlight units 60 . . . turn off and the reference light area backlight units 60a and 60b turn on. Namely, an image in which the normal backlight units 60 . . . turn off and the reference light area backlight units 60a and 60b turn on is repeatedly captured on a regular basis. Therefore, the image analyzing section 24 in the operating device 20 can capture an image of the display screen 90 in which only two reference light areas (the reference light area backlight units 60a and 60b) emit light and also can renew this image periodically.

The following description deals with a process of the image analyzing section 24 in details. When an image captured by the image sensing device 23 is transmitted to the image analyzing section 24, the A/D converter 71 converts analogue signal of the captured image to digital data.

Then the coordinates calculating section 72 in the image analyzing section 24 detects the pointed position (the position pointed by the operating device 20) by calculating coordinates in a coordinate system of the display screen 90 based on the captured image.

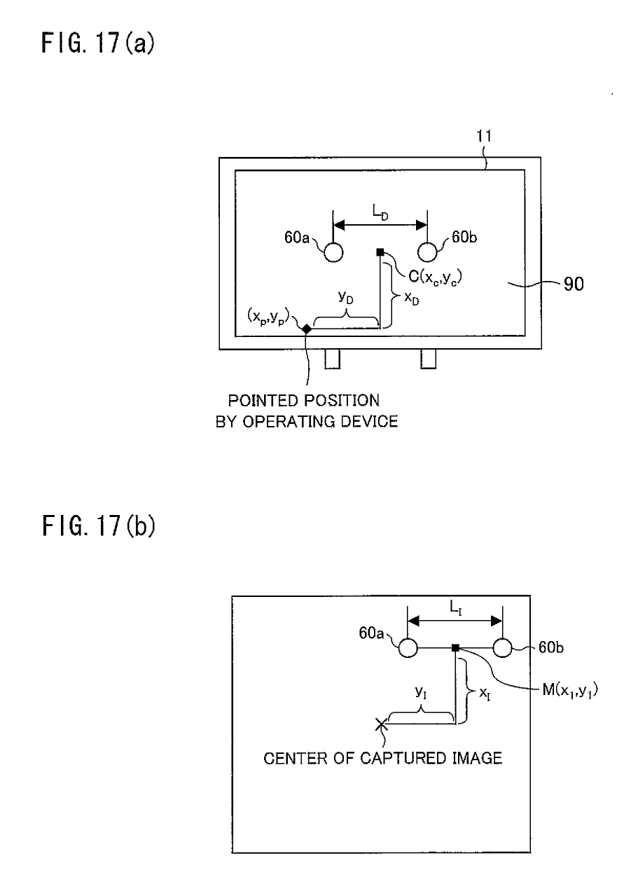

The following description deals with a calculation process of the coordinates. As illustrated in FIG. 17 (b), the image captured by the image sensing device 23 is used as a coordinate system and a center of the image (a position pointed by the operating device 20) is set to be an origin of coordinates. Then, coordinates (x_{I}, y_{I}) of a midpoint M between the reference light area backlight units 60a and 60b is calculated by analyzing the captured image, and then a distance L_{I} between the reference light area backlight units 60a and 60b in the coordinate system of the captured image is calculated.

Then, as illustrated in FIG. 17 (a), the display screen 90 of the liquid crystal display apparatus 10 is used as a coordinate system. In the coordinate of the display screen 90, a distance between the reference light area backlight units 60a and 60b is represented by L_{D}; and coordinates of a position on the display screen 90 pointed by the operating device 20 is represented by (xₚ, yₚ); coordinates of a midpoint C between the reference light area backlight units 60a and 60b is represented by (x_{c}, y_{c}); a difference between x coordinate value of the pointed position and x coordinate value of the midpoint C is represented by x_{D}; and a difference between y coordinate value of the pointed position and y coordinate value of the midpoint C is represented by y_{D}.

The coordinates calculating section 72 calculates a conversion coefficient C from the following equation 1 by substituting the distance L_{I} and the distance L_{D} into equation 1, where the distance L_{I} is obtained by analyzing the captured image, and the distance L_{D} is calculated by and supplied from the liquid crystal display apparatus 10. The conversion coefficient C is a coefficient for converting a value in the coordinate system of the captured image to a value in the coordinate system of the display screen 90.

$$C = \frac{{L}_{D}}{{L}_{I}} \qquad Equation 1$$

Next, the x_{D} and y_{D} (see FIG. 17 (a)) can be calculated from the following equations 2 by substituting the conversion coefficient C, and the coordinates of the midpoint M (x_{I}, y_{I}) in equation 2 where the coordinates of the midpoint M (x_{I}, y_{I}) are obtained by analyzing the captured image.

$$\{ \begin{matrix}{x}_{D} = c \times {x}_{I} \\ {y}_{D} = c \times {y}_{I}\end{matrix} \qquad Equation 2$$

Further, the coordinates (x_{P}, y_{P}) can be calculated using the following equations 3 by substituting x_{D} and y_{D} into equation 3, where x_{D} and y_{D} are obtained by calculating the equation 2, and the coordinates of the midpoint C (x_{c}, y_{c}) previously memorized in a memory section (not-illustrated).

$$\{ \begin{matrix}{x}_{p} = {x}_{c} - {x}_{D} \\ {y}_{p} = {y}_{c} - {y}_{D}\end{matrix} \qquad Equation 3$$

Namely, the coordinates calculation section 72 carries out arithmetic processes of the equations 1 through 3 based on the analysis result of the captured image. As a result, the coordinates (xₚ, yₚ) in the coordinate system of the display screen 90 that represent the position on the display screen 90 pointed by the operating device 20 can be calculated. The image analyzing section 24 detects the pointed position on the display screen 90 by using thus calculated coordinates.

After that, the controlling section 26 controls the communication module 27 to transmit the coordinates (xₚ, yₚ) calculated by the image analyzing section 24 to the liquid crystal display apparatus 10. On a side of the liquid crystal display apparatus 10, the communication module 13 receives the coordinates (xₚ, yₚ), and the coordinates are inputted to the display controlling section 31. Then, the display controlling section 31 determines the position, on the display screen 90, pointed by the operating device 20 based on the coordinates (xₚ, yₚ) and displays a predetermined image (such as a mark indicating the pointed position) on the pointed position.

According to the above described display system 1 of the present embodiment, as illustrated in FIG. 10, the reference light areas are set inside the display screen 90 by functioning the reference light area backlight units 60a and 60b as the reference light areas. This can prevent the reference light areas from being out of a range in which the operating device 20 can capture an image, even though a distance between the liquid crystal display apparatus 10 and the operating device 20 is short, unlike a conventional structure in which reference light areas are located outside of a frame of a display screen.

Further, in the display system 1 of the present embodiment, the blinking controlling section 34 causes the reference light area backlight units 60a and 60b to turn on while turning off all the other backlight units (normal backlight units) as illustrated in FIG. 11. Therefore, the reference light area backlight units to be distinguished from the normal backlight units during the light-off period of the normal backlight units. This allows clear awareness of the reference light area backlight units as the reference light areas.

In the present embodiment, the blinking controlling section 34 controls blinking actions of all the backlight units 60 . . . provided in the liquid crystal display apparatus 10 in accordance with the timing chart shown in FIG. 11. However, a driving timing of the backlight units 60 . . . is not specifically limited to the timing chart shown in FIG. 11.

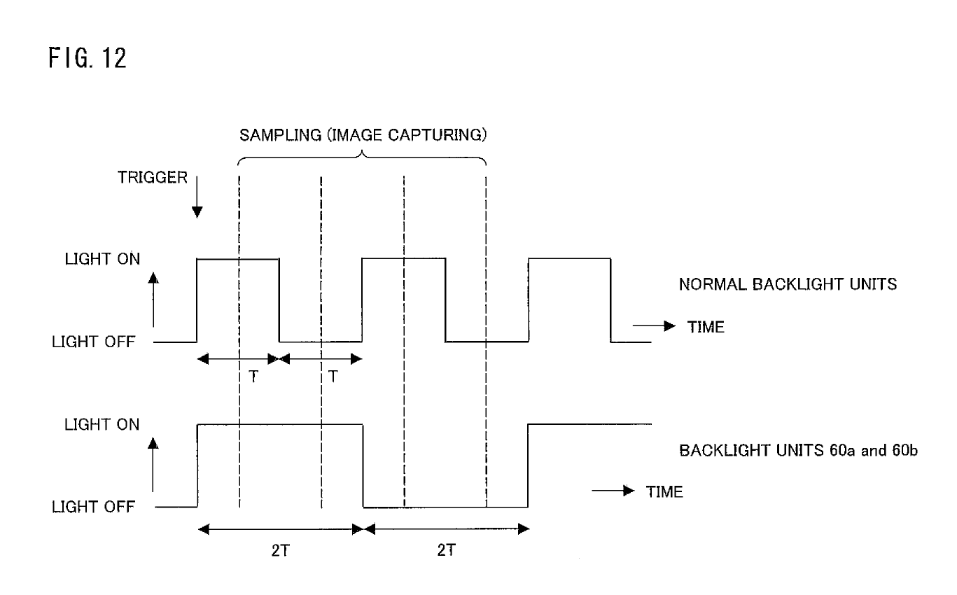

For example, in the timing chart in FIG. 11, a light-on period in one blinking cycle of the reference light area backlight units 60a and 60b is half of a light-on period in one blinking cycle of the normal backlight units 60. A light-off period in one blinking cycle of the reference light area backlight units 60a and 60b is half of a light-off period in one blinking cycle of the normal backlight units 60. As a timing chart shown in FIG. 12, a light-on period in one blinking cycle of the reference light area backlight units 60a and 60b may set twice as long as a turn-on period in one blinking cycle of the normal backlight units 60; and a light-off period in one blinking cycle of the reference light area backlight units 60a and 60b may set twice as long as a light-off period in one blinking cycle of the normal backlight units 60.

Namely, in the timing chart shown in FIG. 12, a blinking action of the normal backlight units 60 . . . repeats light-on and light-off in such a manner that T hour light-on period and T hour light-off period are combined as one cycle. A blinking action of the reference light area backlight units 60a and 60b repeats light-on and light-off in such a manner that 2T hour light-on period and 2T hour light-off period are combined as one cycle. Further, the blinking controlling section 34 controls (i) the light-on timing of the normal backlight units 60 . . . and (ii) the light-on timing of the reference light area backlight units 60a and 60b to be in sync with each other, at an input timing of a trigger signal for indicating activation of the backlight units 60 . . . . Accordingly, as shown in FIG. 12, the light-on timing and the light-off timing of the reference light area backlight units 60a and 60b are always in sync with the light-on timing of the normal backlight units 60. Therefore, the light-on period of the reference light area backlight units 60a and 60b includes at least a light-off period of the normal backlight units 60. As a result, it is possible that only the reference light area backlight units 60a and 60b to turn on periodically and momentarily within the display screen 90 of the liquid crystal display apparatus 10 in accordance with the timing chart shown in FIG. 12. (Namely, it is possible to make (i) all the normal backlight units 60 turn off and (ii) the reference light area backlight units 60a and 60b emit light, momentarily and periodically, within the display screen 90.) This allows the reference light area backlight units 60a and 60b to function as the reference light areas.

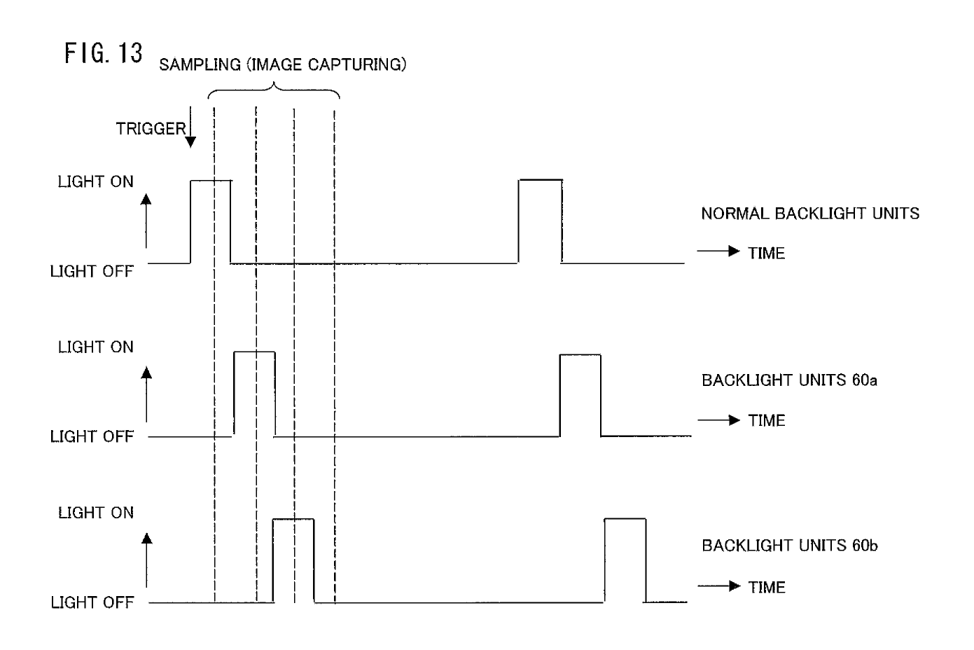

In the timing charts shown in FIG. 11 and FIG. 12, a blinking condition of the reference light area backlight unit 60a and a blinking condition of the reference light area back light unit 60b are the same. As is shown in the timing chart in FIG. 13, however, a blinking condition of the reference light area backlight unit 60a and a blinking condition of the reference light area backlight unit 60b may be different. Specifically, in the timing chart shown in FIG. 13, a light-on period of the normal backlight units 60, a light-on period of the reference light area backlight unit 60a, and a light-on period of the reference light area backlight unit 60b are all the same. However, a timing of starting the light-on period of the normal backlight units 60, a timing of starting the light-on period of the reference light area backlight unit 60a, and a timing of starting the light-on period of the reference light area backlight unit 60b are set all different. More specifically, in the timing chart shown in FIG. 13, (i) during the light-on period of the reference light area backlight unit 60a, the normal backlight units 60 . . . and the reference light area backlight unit 60b turn off; (ii) during the light-on period of the reference light area backlight unit 60b, the normal backlight units 60 . . . and the reference light area backlight unit 60a turn off.

The following description deals with advantages in a case where a blinking condition of the reference light area backlight unit 60a and a blinking condition of the reference light area backlight unit 60b are different as shown in FIG. 13.

For example, as illustrated in FIG. 17 (a), in a case where a position pointed by the operating device 20 (indicated position) is located below the reference light area backlight units 60a and 60b on display screen 90 and the operating device 20 is in a normal position (in a case where (i) a direction of x-axis and a direction of y-axis in a coordinate system of the display screen and (ii) a direction of x-axis and a direction of y-axis in a coordinate system of an image captured by the operating device 20 are identical), the position pointed by the operating device 20 (a center of the captured image) is located below the reference light area backlight units 60a and 60b in a captured image, as illustrated in FIG. 17 (b).

As illustrated in FIG. 17 (a), however, in a case where a position, on the display screen 90, pointed by the operating device 20 is located below the reference light area backlight units 60a and 60b but the operating device 20 is rotated 180 degree from the normal position (the operating device is up side down), a position pointed by the operating device 20 (a center of the captured image) is located above the reference light area backlight units 60a and 60b in a captured image. (Namely, the captured image is an up side down image of FIG. 17 (b).)

Therefore, it is necessary that the image analyzing section 24 in the operating device 20 determines an angle of rotation (an angle of rotation from the normal position), and corrects the captured image by carrying out a rotation by the determined rotation angle so that the captured image is back to the normal state. Without this procedure, coordinates (xₚ, yₚ) calculated by the image analyzing section 24 would be wrong values, thereby failing to detect a pointed position on the display screen 90 accurately.

In a case where the blinking controlling section 34 controls blinking conditions of the reference light area backlight unit 60a and the reference light area backlight unit 60b so as to be different from each other as the timing chart shown in FIG. 13, the image analyzing section 24 in the operating device 20 has an advantage of easy determination of a rotation angle of the operating device 20. The following description deals with this advantage in details. According to the timing chart in FIG. 13, in the display screen 90, while the reference light area backlight unit 60a turns on, the reference light area backlight unit 60b turns off; and while the reference light area backlight unit 60b turns on, the reference light area backlight unit 60a turns off. This allows the image analyzing section 24 to distinguish the reference light area backlight unit 60a and the reference light area backlight unit 60b from between the two reference light areas in images captured at timings (i) when the reference light area backlight unit 60a turns on and (ii) when the reference light area backlight unit 60b turns on. Then, the image analyzing section 24 calculate a rotation angle of the operating device 20 by using coordinates of the reference light area backlight units 60a and 60b in the coordinate system of the display screen 90 (which have been memorized in advance) and coordinates of the reference light area backlight units 60a and 60b in the coordinate system of the captured image. For example, the rotation angle can be calculated using a relation between (i) a slope of a line connecting the reference light area backlight units 60a and 60b in the coordinate system of the display screen 90 and (ii) a slope of a line connecting the reference light area backlight units 60a and 60b in the coordinate system of the captured image. Further, the rotation angle can be calculated by using a magnitude relation between (i) x-coordinates of the reference light area backlight units 60a and 60b in the coordinate system of the display screen 90 and (ii) x-coordinates of the reference light area backlight units 60a and 60b in the coordinate system of the captured image. Moreover, the rotation angle can be calculated by using a magnitude relation between (i) y-coordinates of the reference light area backlight units 60a and 60b in the coordinate system of the display screen 90 and (ii) y-coordinates of the reference light area backlight units 60a and 60b in the coordinate system of the captured image.

The image analyzing section 24 in the operating device 20 (i) determines a rotation angle of the operating device 20; (ii) carries out a rotation of the captured image by the determined rotation angle; and then (iii) calculates coordinates (xₚ, yₚ) based on the captured image which has been rotated. Thus obtained coordinates (xₚ, yₚ) are accurate regardless of the rotation angle of the operating device 20.

Further, in the present embodiment, the backlight units 60a and 60b are used as the reference light areas among all the backlight units 60 . . . provided in the liquid crystal display apparatus 10. However, the reference light area backlight units may be altered in every predetermined period of time. Specifically, the liquid crystal display device 10 may have a selecting section for selecting reference light area backlight units from among all the backlight units 60 . . . provided in the liquid crystal display apparatus 10, the selecting section alters reference light area backlight units to be selected every time a predetermined period passes.

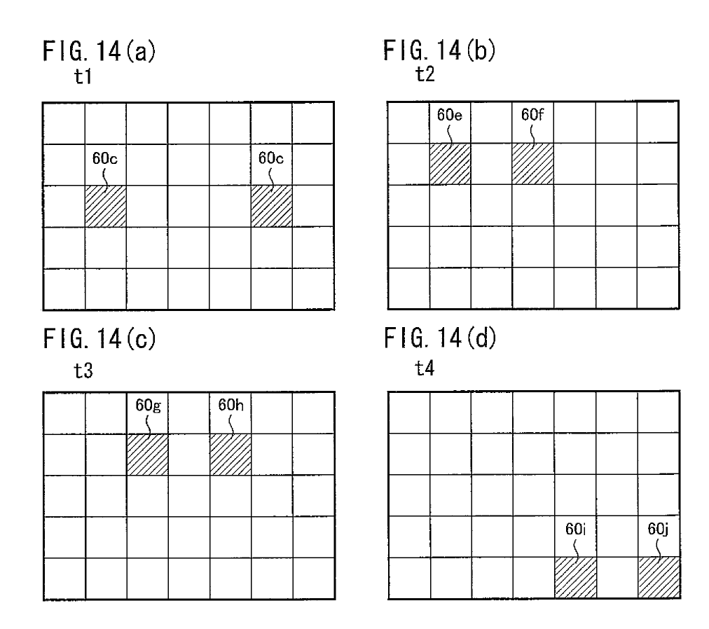

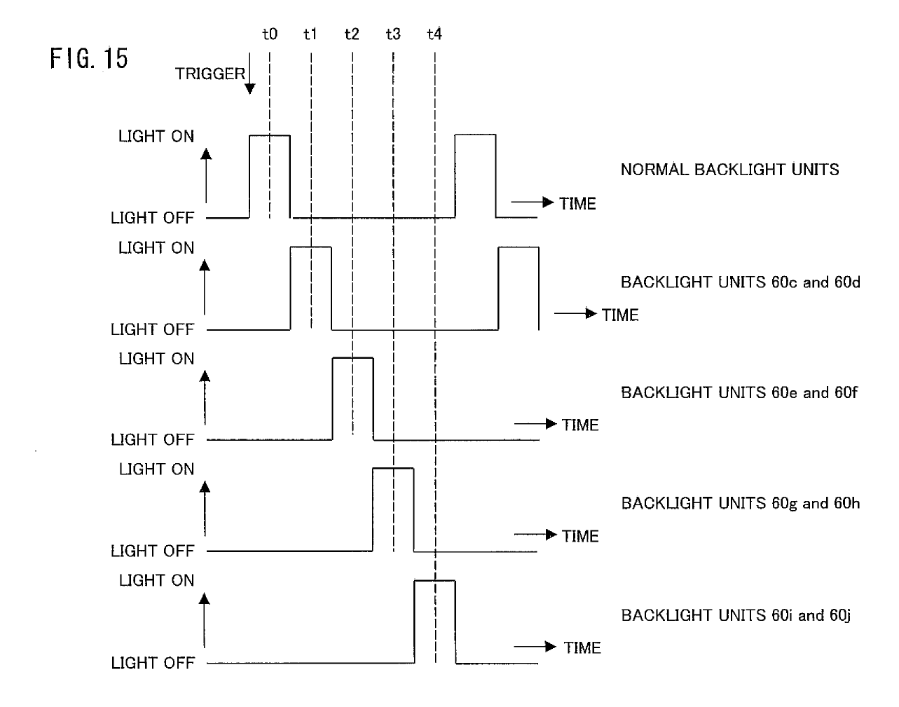

For example, as illustrated in FIG. 15, the backlight units 60 . . . turn on at a time t0. At a time t1 when a certain period of time passed from the time to, the selecting section selects backlight units 60c and 60d illustrated in FIG. 14 and the blinking controlling section 34 turns on only the selected backlight units 60c and 60d. At a time t2 when a certain period of time passed from the time t1, the selecting section selects backlight units 60e and 60f illustrated in FIG. 14, and the blinking controlling section 34 turns on only the selected backlight units 60c and 60f. At a time t3 when a certain period of time passed from the time t2, the selecting section 34 selects backlight units 60g and 60h, and the blinking controlling section 34 turns on only the selected backlight units 60g and 60h. At a time t4 when a certain period of time passed from the time t3, the selecting section selects backlight units 60i and 60j illustrated in FIG. 14, and the blinking controlling section 34 turns on only the selected backlight units 60i and 60j. This allows positions of backlight units which function as reference light areas to be altered inside the display screen 90 at each of the time t1, time t2, time t3, and time t4. Therefore, it is possible to arrange reference light areas anywhere inside the display screen 90. Even in a case where the display screen 90 is a large display, the operating device 20 can surely capture an image including reference light areas. This allows a position, on the display screen 90, pointed by the operating device 20 to be determined properly.

In the timing charts in FIG. 11 through 13 and FIG. 15, during the light-off period of the normal backlight units 60 . . . , a reference light area backlight unit turns on so as to function as a reference light area. However, the present embodiment is not specifically limited to this. It may be possible that, during the light-on period of the normal backlight units 60 . . . , a reference light area backlight unit turns off so as to function as a reference light area. (Namely, momentarily and periodically, it is possible to make the reference light area backlight unit turn off while turning on all the normal backlight units 60 . . . . )

In a case where the operating device 20 captures an image of the display screen 90 at a time when only reference light area backlight units 60k and 60l turn off and the normal backlight units 60 . . . turn on, the reference light area backlight units 60k and 60l are noticeable on the display screen 90 in the captured image. This allows detecting positions of the reference light area backlight units 60k and 60l.

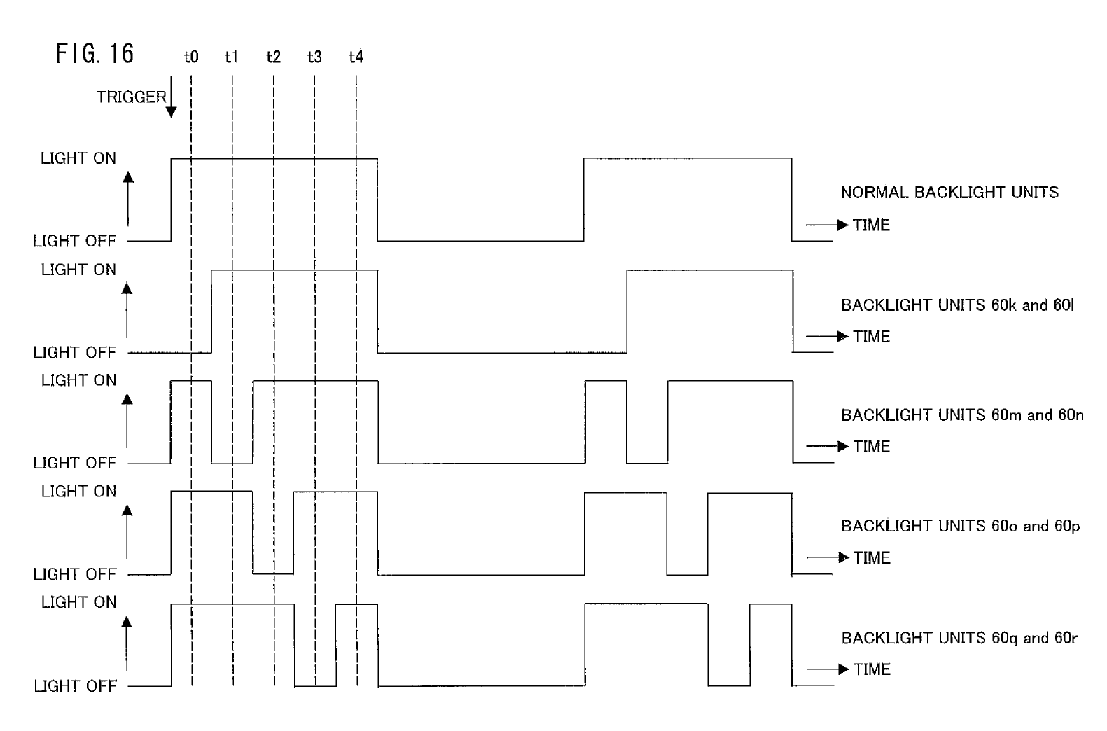

For example, in a case where the blinking controlling section 34 activates the backlight units 60 . . . in accordance with a timing chart shown in FIG. 16, backlight units 60k and 60l turn off and all the other backlight units 60 . . . turn on at a time t0 so that the backlight units 60k and 60l function as the reference light areas. At a time t1, backlight units 60m and 60n turn off and all the other backlight units 60 . . . turn on so that the backlight units 60m and 60n function as the reference light areas. At a time t2, backlight units 60o and 60p turn off and all the other backlight units 60 . . . turn on so that the backlight units 60o and 60p function as the reference light areas. At a time t3, backlight units 60q and 60r turn off and all the other backlight units 60 . . . turn on so that the backlight units 60q and 60r function as the reference light areas. At last, at a time t4, all the backlight units 60 . . . provided in the liquid crystal display apparatus 10 turn on and one cycle is completed.

In the timing charts in FIG. 11 through FIG. 13 and FIG. 15, all the backlight units 60 . . . provided in the liquid crystal display apparatus 10 have the same ratio of light-on period in one cycle of a blinking action (have the same duty ratio). Therefore, even when a blinking condition of the reference light area backlight units and a blinking condition of all the other backlight units are different, all the backlight units 60 have the same light-on period in total. This prevents the reference light areas of the display screen 90 from becoming noticeable to human eyes (viewer).

Further, in the present embodiment, the image analyzing section 24 is provided in the operating device 20 (see FIG. 3). However, the image analyzing section 24 may be provided in the liquid crystal display apparatus 10. In a case where the image analyzing section 24 is provided in the liquid crystal display apparatus 10, it is necessary to transmit a captured image, which has a large amount of data, to the liquid crystal display apparatus 10 from the operating device 20. However, it is not necessary to transmit the captured image from the operating device 20 to the liquid crystal display apparatus 10 in a case where the image analyzing section 24 is provided in the operating device 20. Therefore, it is preferable that the image analyzing section 24 is provided in the operating device 20.

As the timing chart shown in FIG. 13, it may have a period when all the backlight units 60 . . . turn off after a completion of one blinking action cycle and before starting the next cycle. This provides a period for detecting when to input the next trigger signal after an input of the trigger signal to start a blinking action.

In a case where “1” represents ON and “0” represents OFF (in the same way hereinafter) in the timing chart shown in FIG. 13, a control signal to be inputted to the normal backlight units 60 . . . is “1000” in one cycle; a control signal to be inputted to the backlight unit 60a is “0100” in one cycle; and a control signal to be inputted to the backlight unit 60b is “0010” in one cycle.

In the timing chart shown in FIG. 15, a control signal to be inputted to the normal backlight units 60 . . . is “10000” in one cycle; a control signal to be inputted to the backlight units 60c and 60d is “01000” in one cycle; a control signal to be inputted to the backlight units 60e and 60f is “00100” in one cycle; a control signal to be inputted to the backlight units 60g and 60h is “00010” in one cycle; and a control signal to be inputted to the backlight units 60i and 60j is “00001” in one cycle.

In the timing chart shown in FIG. 16, a control signal to be inputted to the normal backlight units 60 . . . is “11111” in one cycle; a control signal to be inputted to the backlight units 60k and 60l is “01111” in one cycle; a control signal to be inputted to the backlight units 60m and 60n is “10111” in one cycle; a control signal to be inputted to the backlight units 60o and 60p is “11011” in one cycle; and a control signal to be inputted to the backlight units 60q and 60r is “11101” in one cycle.

### [Modification]

The following description deals with a modification. In the present modification, not only calculating coordinates of a pointed position (indicated position) in a coordinate system of a display screen 90 based on an image captured by an operating device 20, but also altering backlight units as reference light areas so as to make them closer to the pointed position (i.e., positions of the reference light areas are changed). This makes it easier to include the reference light areas within a range in which the operating device 20 can capture an image, even though a distance between the operating device 20 and the display screen 90 is short.

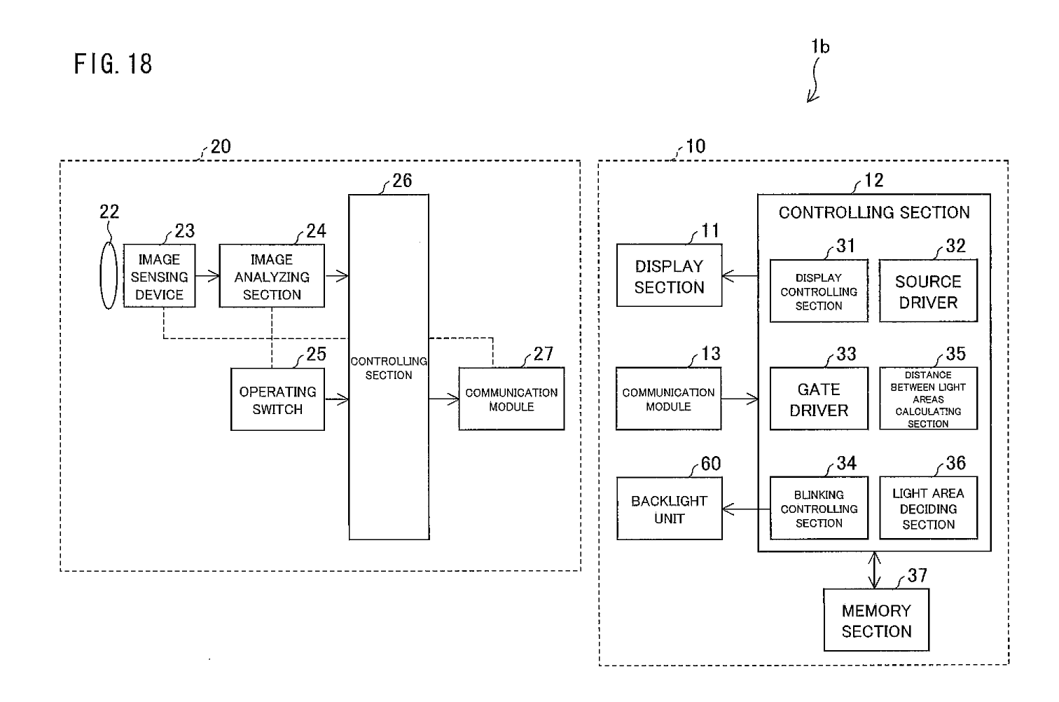

FIG. 18 is a block diagram illustrating an overview structure of a display system 1b of the present modification. As illustrated in FIG. 18, the display system 1b has the same arrangement as the display system 1 illustrated in FIG. 3, and additionally includes a distance between light areas calculating section 35, a light area deciding section 36, and a memory section 37. The distance between light areas calculating section 35, the light area deciding section 36, and the memory section 37 are provided in a liquid crystal display device 10. More specifically, the distance between light areas calculating section 35 and the light area deciding section 36 are provided in a controlling section 12.

The distance between light areas calculating section 35 calculates a distance between reference light areas that are being displayed on a display screen 90. In the present modification, a distance L_{D} between reference light area backlight units 60a and 60b in a coordinate system of the display screen 90 is calculated.

The light area deciding section 36 receives, from the image analyzing section 24 in the operating device 20 via the communication module 13, (i) coordinates (xₚ, yₚ), which are a position, on the display screen 90, pointed by the operating device 20 and (ii) a distance L_{I} between the reference light area backlight units 60a and 60b in a coordinate system of a captured image. Then, the light area deciding section 36 decides altered reference light area backlight units based on the coordinates (xₚ, yₚ), distance L_{I}, and distance L_{D} calculated by the distance between light areas calculating section 35.

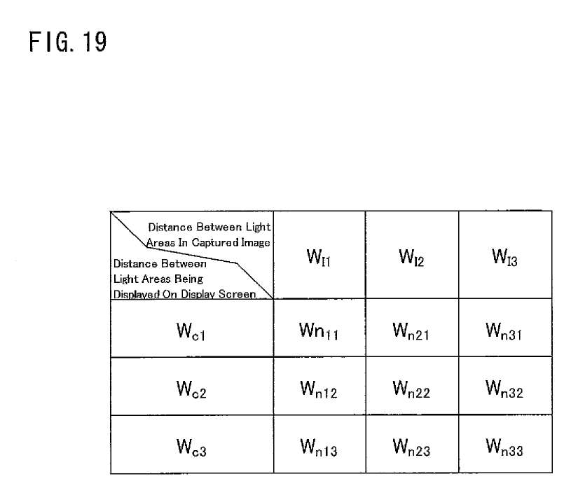

As illustrated in FIG. 19, the memory section 37 stores in advance a lookup table in which (i) a distance, in a horizontal direction, between reference light areas which are being displayed in the coordinate system of the display screen 90 (W_{c1} to W_{c3}), (ii) a distance, in a horizontal direction, between reference light areas which are being displayed in the coordinate system of the captured image (W_{I1} to W_{I3}), and (iii) a distance, in a horizontal direction, between altered (set) reference light areas (Wₙ₁₁ to Wₙ₃₃) are correlated with one another. The distance, in the lookup table, between altered reference light areas is set to become shorter as the distance between the display screen 90 and the operating device 20 becomes shorter. A distance, in a vertical direction, between the reference light areas is set so that a ratio of the distance in the vertical direction to the distance in the horizontal direction becomes constant. Accordingly, when the altered distance in the horizontal direction is determined, the distance in the vertical direction can be calculated based on the distance in the altered distance in the horizontal direction. The arrangement of the lookup table is not limited to this. For example, both of the distance in the horizontal direction and the distance in the vertical direction may be stored in the lookup table.

The light area deciding section 36 refers to the lookup table so as to obtain a distance between altered reference light areas which distance corresponds to a distance between the reference light areas that are being displayed on the display screen 90 and a distance between the reference light areas in a captured image. Then the light area deciding section 36 selects altered reference light area backlight units so that each of the reference light areas is displayed, according to the obtained distance between the altered reference light area backlight units, in the vicinity of coordinates (xₚ, yₚ) in the coordinate system of the display screen 90. More specifically, the altered reference light area backlight units are decided so that the coordinates (xₚ, yₚ) of the pointed position that is calculated based on the reference light area backlight units 60a and 60b before the alteration of the display positions agrees with a midpoint of the reference light area backlight units that are obtained after alteration of the positions of the reference light area backlight units.

As above described, in the display system 1b of the present modification, the coordinates (xₚ, yₚ) of a pointed position on a display screen 90 that is pointed by the operating device 20 are calculated, based on the reference light area backlight units 60a and 60b that are being displayed on the display screen 90, and positions of the reference light area backlight units are altered so that the reference light areas are displayed in the vicinity of the coordinates (xₚ, yₚ) thus calculated. This causes each of the reference light areas to be always displayed in the vicinity of a position that is pointed by the operating device 20. As a result, it is possible to prevent a pointed position on the display screen 90 from being out of a range in which the operating device 20 can capture an image in a case where the position pointed by the operating device 20 is changed from one to another.

Further, in the present modification, backlight units which function as reference light areas are altered so that the distance between the reference light areas become shorter as the distance between the display screen 90 and the operating device 20 become shorter. This allows the reference light areas to be displayed within a range in which the operating device 20 can capture an image. Therefore, regardless of the distance between the display screen 90 and the operating device 20, the coordinates (xₚ, yₚ) which are the position pointed by the operating device 20 can be properly detected.

In other words, in the present modification, the liquid crystal display apparatus 10 includes a selecting section (controlling section 12) for selecting reference light area backlight units from among all the backlight units 60 . . . provided in the liquid crystal display apparatus 10. The selecting section detects a pointed position by receiving location information indicating the pointed position from the image analyzing section 24, and selects backlight units, which are closer to the pointed position than the current reference light area backlight units, as the next reference light area backlight units. This allows the reference light areas to be arranged in the vicinity of the position pointed by the operating device 20. Therefore, it is possible to detect the position on the display screen 90 pointed by the operating device 20 more properly because the reference light areas are surely included in a captured image even when a distance between the operating device 20 and the display screen 90 is short.

The present modification provides an explanation on an arrangement in which the lookup table in the memory section 37 is referred to when an altered distance between the reference light areas is calculated. However, the present modification is not limited to the arrangement. For example, the memory section 37 stores a function that correlates (i) a distance between reference light areas, being displayed on a display screen 90, in the coordinate system of the display screen, (ii) a distance between the reference light areas in the coordinate system of a captured image, and (iii) an altered (set) distance between the reference light areas. And, an altered distance between the reference light areas is calculated by the function.

In the embodiment, two reference light areas are displayed in the display screen 90. However, the number of the reference light areas should be two or more and should not be specifically limited to be two.

As described above, a display system of the present embodiment includes a liquid crystal display apparatus including a display screen; a plurality of backlight units for illuminating the display screen; and a blinking controlling section for controlling a blinking action of each of the backlight units, an operating device which is capable of pointing a position on the display screen of the liquid crystal display apparatus from a distance and capturing an image of the liquid crystal display apparatus so as to obtain the captured image including the pointed position; and an image analyzing section for analyzing the captured image obtained by the capture to detect two or more reference light areas in the liquid crystal display apparatus so that the image analyzing section detects the pointed position on the display screen based on positions of the reference light areas in the captured image, the blinking controlling section controlling blinking conditions of all the backlight units provided in the liquid crystal display apparatus so as to differ a blinking condition of two or more reference light area backlight units from that of the other backlight units, so that the image analyzing section detects the reference light area backlight units as the reference light areas.

The structure allows two or more backlight units, among the plurality of backlight units which are provided inside the liquid crystal display apparatus, to function as the reference light areas. Therefore, the reference light areas are located inside the display screen. This can prevent the reference light areas of the liquid crystal display apparatus from being out of a range in which the operating device can capture an image, even though a distance between the liquid crystal display apparatus and the operating device is short, unlike a conventional arrangement in which reference light areas are provided outside of a frame of a display screen. Therefore, it is possible to detect a position on the display screen pointed by an operating device more properly than before, regardless of a distance between the operating device and the liquid crystal display apparatus.

Further, in the display system of the present embodiment, the image analyzing section may be provided either in the operating device or in the liquid crystal display device. However, it is preferable that the image analyzing section is provided in the operating device. This is because it is necessary to transmit a captured image, which is a large amount of data, to the liquid crystal display apparatus in a case where the image analyzing section is provided in the liquid crystal display apparatus; however, it is not necessary to transmit the captured image from the operating device to the liquid crystal display apparatus in a case where the image analyzing section is provided in the operating device.

Further, in the display system of the present embodiment, it is preferable that the blinking controlling section turns on the reference light area backlight units while turning off all the other backlight units. Accordingly, only the reference light area backlight units to be distinguished during the light-off period of all the other backlight units. This allows certain awareness of the reference light area backlight units as the reference light areas.

If the reference light areas were so noticeable as to be identified by human eyes (viewer), the reference light areas would be obstacle for displaying an image on the display screen. Therefore, in the display system of the present embodiment, it is preferable that the blinking controlling section controls all the backlight units of the liquid crystal display apparatus in such a manger that all the backlight units have a same ratio of light-on period in one cycle of a blinking action. This allows all the backlight units have the same light-on period in total. As a result, it is possible to prevent the reference light areas from being so distinct on the display screen that human eyes (viewer) can detect.

Further, in the display system of the present embodiment, it is preferable that the liquid crystal display apparatus includes a selecting section for selecting the reference light area backlight units from among all the backlight units provided in the liquid crystal display apparatus, the selecting section alters reference light area backlight units to be selected every time a predetermined period passes. This allows the reference light areas to be arranged anywhere inside the display screen. It is possible to detect the position pointed by the operating device regardless of a distance between the operating device and the liquid crystal display apparatus, even in a case where the display screen is a large display screen.

Further, in the display system of the present embodiment, it is preferable that the liquid crystal display apparatus includes a display controlling section for displaying an image on the display screen, and the display controlling section receives location information from the image analyzing section, the location information being indicative of the pointed position, and displays a predetermined image at the pointed position on the display screen based on location information. As a result, when a position on the display screen is pointed by the operating device, the predetermined image is displayed on the pointed position.

Further, in the display system of the present embodiment, it is preferable that the blinking controlling section controls blinking conditions of a first-reference light area backlight unit and a second-reference light area backlight unit so as to be different from each other. This allows the pointed position on the display screen to be detected accurately even in a case where the operating device is up side down at the time when the image is captured.

Further, in the display system of the present embodiment, it is preferable that the liquid crystal display apparatus includes a selecting section for selecting the reference light area backlight units from among all the backlight units provided in the liquid crystal display apparatus, and the selecting section detects the pointed position based on location information that indicates the pointed position and is supplied from the image analyzing section, and selects backlight, which are closer to the pointed position than the current reference light area backlight units, as next reference light area backlight units. This allows the reference light areas to be arranged in the vicinity of the position pointed by the operating device. Therefore, it is possible to properly detect the position pointed by the operating device because the reference light areas are surely included in a captured image even when a distance between the operating device and the display screen is short.

Further, a liquid crystal display apparatus of the present embodiment included in a display system, the display system including: an operating device which is capable of pointing a position on a display screen of the liquid crystal display apparatus from a distance and capturing an image of the liquid crystal display apparatus so as to obtain the captured image including the pointed position; and an image analyzing section for analyzing the captured image obtained by the capture and detecting two or more reference light areas in the liquid crystal display apparatus so that the image analyzing section detects the pointed position on the display screen based on positions of the reference light areas in the captured image, the liquid crystal display apparatus including: the display screen; the plurality of backlight units for illuminating the display screen; and a blinking controlling section for controlling a blinking action of each of the backlight units, the blinking controlling section controlling blinking conditions of all the backlight units provided in the liquid crystal display apparatus so as to differ a blinking condition of two or more reference light area backlight units from that of the other backlight units, so that the image analyzing section detects the reference light area backlight units as the reference light areas.

The present embodiment is applicable to a display system including a display device, and an operating device which is capable of pointing a position on a display screen of the display device from a distance. For example, it is applicable to a pointing device which is capable of pointing a position on a display screen which displays images such as presentation in a meeting, a game, or the like.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A display system comprising:
a liquid crystal display apparatus comprising:
a display screen;
a plurality of backlight units for illuminating the display screen; and
a blinking controlling section for controlling a blinking action of each of the plurality of backlight units,
an operating device which is capable of pointing a position on the display screen of the liquid crystal display apparatus from a distance and capturing an image of the liquid crystal display apparatus so as to obtain the captured image including the pointed position; and
an image analyzing section for analyzing the captured image obtained by the capture to detect two or more reference light areas in the liquid crystal display apparatus so that the image analyzing section detects the pointed position on the display screen based on positions of the reference light areas in the captured image,
the blinking controlling section controlling blinking conditions of all the backlight units provided in the liquid crystal display apparatus so as to differ a blinking condition of two or more reference light area backlight units from that of the other backlight units, so that the image analyzing section detects the reference light area backlight units as the reference light areas.

2. The display system according to claim 1, wherein:
the image analyzing section is provided in the operating device.

3. The display system according to claim 1, wherein:
the blinking controlling section turns on the reference light area backlight units while turning off all the other backlight units.

4. The display system according to claim 1, wherein:
the blinking controlling section controls all the backlight units of the liquid crystal display apparatus in such a manner that all the backlight units have a same ratio of light-on period in one cycle of a blinking action.

5. The display system according to claim 1, wherein:
the liquid crystal display apparatus includes a selecting section for selecting the reference light area backlight units from among all the backlight units provided in the liquid crystal display apparatus,
the selecting section alters reference light area backlight units to be selected every time a predetermined period passes.

6. The display system according to claim 1, wherein:
the liquid crystal display apparatus includes a display controlling section for displaying an image on the display screen, and
the display controlling section receives location information from the image analyzing section, the location information being indicative of the pointed position, and displays a predetermined image at the pointed position on the display screen based on the location information.

7. The display system according to claim 1, wherein:
the blinking controlling section controls blinking conditions of a first-reference light area backlight unit and a second-reference light area backlight unit so as to be different from each other.

8. The display system according to claim 1, wherein:
the liquid crystal display apparatus includes a selecting section for selecting the reference light area backlight units from among all the backlight units provided in the liquid crystal display apparatus, and
the selecting section detects the pointed position based on location information that indicates the pointed position and is supplied from the image analyzing section, and selects backlight units, which are closer to the pointed position than the current reference light area backlight units, as next reference light area backlight units.

9. A liquid crystal display apparatus included in a display system,
the display system comprising:
an operating device which is capable of pointing a position on a display screen of the liquid crystal display apparatus from a distance and capturing an image of the liquid crystal display apparatus so as to obtain the captured image including the pointed position; and
an image analyzing section for analyzing the captured image obtained by the capture and detecting two or more reference light areas in the liquid crystal display apparatus so that the image analyzing section detects the pointed position on the display screen based on positions of the reference light areas in the captured image,
the liquid crystal display apparatus comprising:
the display screen;
the plurality of backlight units for illuminating the display screen; and
a blinking controlling section for controlling a blinking action of each of the backlight units,
the blinking controlling section controlling blinking conditions of all the backlight units provided in the liquid crystal display apparatus so as to differ a blinking condition of two or more reference light area backlight units from that of the other backlight units, so that the image analyzing section detects the reference light area backlight units as the reference light areas.
